(19) United States
(12) Patent Application Publication
(10) Pub. No.: US 2025/0391208 A1
(43) Pub. Date: Dec. 25, 2025

(54) METHOD FOR DETECTING DAMAGE TO A WHEEL HUB MOTOR OF A MOTOR VEHICLE, AND MOTOR VEHICLE HAVING A WHEEL HUB MOTOR

(71) Applicant: AUDI AG, Ingolstadt (DE)

(72) Inventor: Tobias BROK, Kösching (DE)

(21) Appl. No.: 19/242,735

(22) Filed: Jun. 18, 2025

(30) Foreign Application Priority Data
Jun. 19, 2024 (DE) 102024117213.4

(51) Int. Cl. G07C 5/02; G01C 21/28

(52) U.S. Cl. CPC G07C 5/02; G01C 21/28

(57) ABSTRACT

A method for detecting damage to a wheel hub motor of a motor vehicle driving a wheel, wherein acceleration values acting on the motor vehicle at least in a transverse direction of the motor vehicle are captured by way of at least one acceleration sensor of the motor vehicle during travel and are evaluated by way of a control device of the motor vehicle, wherein the damage to the wheel hub motor is detected if the acceleration values captured in the transverse direction represent an acceleration of a lateral impact of the wheel against an obstacle above a predeterminable load threshold; and motor vehicle having a wheel hub motor.

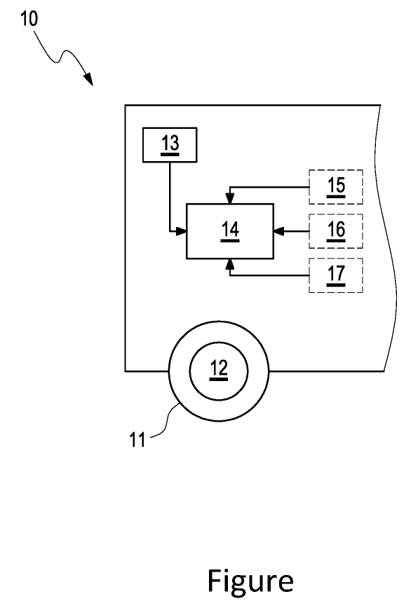

### BACKGROUND

### TECHNICAL FIELD

The disclosure relates to a method for detecting damage to a wheel hub motor of a motor vehicle, and to a motor vehicle having a wheel hub motor.

### DESCRIPTION OF THE RELATED ART

A future trend in motor vehicles is the use of so-called in-wheel drives (wheel hub motors). A wheel hub motor is a motor that is built directly into a motor vehicle's wheel and simultaneously supports the wheel hub. Part of the motor transfers the generated torque to the wheel with which it rotates.

Undetected damage to the wheel hub motor, for example, due to hitting a curb, can lead to mechanical and/or electrical malfunctions of the wheel hub motor. In the case of electric wheel hub motors powered by a high-voltage system (e.g., 400 V or 800 V) of the vehicle, such damage can, in the worst case, lead to the complete destruction of the vehicle (e.g., fire) and/or a life-threatening danger to occupants and helpers (e.g., high-voltage potential on the vehicle body).

### BRIEF SUMMARY

Against this background, embodiments of the disclosure provide a method that enables robust, reliable detection of damage to a wheel hub motor of a motor vehicle and thus increases the safety of vehicle occupants and prevents consequential damage to property (e.g., vehicle fire) and people (e.g., electric shock).

It should be noted that the features listed individually in the claims can be combined with one another in any technically reasonable manner (even across category boundaries, for example, between method and device) and demonstrate further configurations of the disclosure. The description further characterizes and specifies the disclosure, particularly in conjunction with the figures.

It should also be noted that a conjunction "and/or", as used herein, which stands between two features and links them together, is always to be interpreted in such a way that in a first embodiment of the disclosure only the first feature can be present, in a second embodiment only the second feature can be present and in a third both the first and the second feature can be present.

One embodiment of the disclosure is a method for detecting damage to a wheel hub motor of a motor vehicle driving a wheel, wherein acceleration values acting on the motor vehicle at least in a transverse direction of the motor vehicle are captured by way of at least one acceleration sensor of the motor vehicle during travel and are evaluated by way of a control device of the motor vehicle, wherein the damage to the wheel hub motor is detected if the acceleration values captured in the transverse direction represent an acceleration of a lateral impact of the wheel against an obstacle above a predeterminable load threshold.

When an obstacle, such as a curb or other obstacle, is encountered from the side, accelerations are exerted on the chassis and body of the motor vehicle. These accelerations are captured and evaluated by the at least one acceleration sensor and the control device at least in the direction of a transverse axis of the motor vehicle (i.e., in the transverse direction). The captured acceleration values differ from non-damaging events, such as driving over potholes, in particular when the wheel is hit directly from the side by the obstacle. This is detected by the control device, and it is subsequently concluded that the wheel hub motor is damaged. The disclosure therefore dispenses with a direct measurement of properties of the wheel hub motor, such as the instantaneously output drive power, drive torque, or the like. Since acceleration sensors are already installed in modern motor vehicles, they can advantageously be used to reliably determine damage to the wheel hub motor using these acceleration sensors.

The detection of damage to the wheel hub motor performed in this way provides a resource-saving solution, particularly with regard to required hardware components, which contributes to increased safety for vehicle occupants among others and prevents property damage, e.g., vehicle fires, as consequential damage of the damage to the wheel hub motor. The method yields reliable results, thus reducing incorrect detections and, if applicable, resulting false alerts that may be output to a vehicle user, leading to increased acceptance among vehicle users. Furthermore, cost-intensive passive protective measures can be reduced or even eliminated, if appropriate.

Exceeding the acceleration beyond the predefined load threshold constitutes a sufficient condition within the meaning of the disclosure. Additional conditions can be used to verify the plausibility of the captured acceleration values, so that the determined exceedance of the limit value based on the captured acceleration values alone does not necessarily have to lead to the detection of damage to the wheel hub motor.

In an advantageous embodiment, an acceleration sensor of a vehicle dynamics control system and/or an airbag control unit of the motor vehicle is used as the acceleration sensor. The vehicle dynamics control system (ESC) prevents the vehicle from skidding by capturing and evaluating accelerations acting on the vehicle while driving, and initiating appropriate countermeasures in the event of a skidding event. In the event of a collision, the airbag control unit triggers an airbag to protect vehicle occupants. This also requires the capture and evaluation of the accelerations acting on the vehicle during travel. Advantageously, the acceleration sensors already present in the vehicle, or at least one of them, are used in the context of the disclosure, so that the provision of additional sensors can be dispensed with.

In a further advantageous embodiment, the control device causes a warning message to be output to a user of the motor vehicle (e.g., vehicle occupants) by way of which the detected damage to the wheel hub motor is communicated. This can alert the vehicle user, for example, to park the vehicle or to inspect the wheel hub motor, or to have such inspection done.

The information obtained from the at least one acceleration sensor can be supported in its informative quality by further sensor information, so that the risk of false detections or false alerts can be reduced, which can lead to a reduction in confidence in detected damages or displayed alert or damage alert with an associated reduction in user satisfaction.

According to further advantageous embodiments, exceeding the acceleration beyond the load threshold is determined based on an acceleration direction, an acceleration magnitude, and/or an acceleration duration. In order not to limit the acceleration direction exclusively to the transverse direction, but rather to determine an acceleration vector in two or three spatial dimensions, the at least one acceleration sensor can be designed accordingly and/or a plurality of acceleration sensors can be provided in the motor vehicle, each of which capturing the acceleration on the motor vehicle in a different spatial direction.

Through appropriate evaluation of the acceleration values, e.g., by way of so-called "machine learning" and/or driving and laboratory tests, normal, harmless wheel collisions with obstacles can be reliably and accurately distinguished from collisions involving wheel hub motor contact. A system for implementing this method can be trained or programmed accordingly.

To verify the plausibility of the captured acceleration values, in particular the acceleration values which represent an acceleration above the predefined load threshold, at least one ultrasonic sensor of the motor vehicle and/or at least one camera (i.e., a camera sensor) of the motor vehicle and/or at least one radar and/or lidar sensor of the motor vehicle can be used in addition to the at least one acceleration sensor, with which the obstacle in the vicinity of the wheel can be captured, wherein the damage to the wheel hub motor is only detected if, in addition to the acceleration values representing the lateral impact of the wheel against the obstacle, the obstacle is also captured by way of the at least one ultrasonic sensor or the at least one camera or the at least one radar and/or lidar sensor.

The at least one ultrasonic sensor can be, for example, an ultrasonic sensor of a parking aid of the motor vehicle. The camera of the motor vehicle can be a camera for pedestrian protection that captures the surroundings of the motor vehicle. The at least one radar/lidar sensor can be provided for automated driving. It should be understood that, in addition to the acceleration values, the control device receives the measured values of the respective additional sensors and takes them into account accordingly when detecting damage to the wheel hub motor.

The information from at least one acceleration sensor alone can provide sufficiently accurate indications of damage to the wheel hub motor. Combining it with information from the various other sensors mentioned above can significantly increase robustness and thus user acceptance, because it also prevents incorrect detection of damage or unnecessary alerts for the vehicle user.

If, for example, the ultrasonic, lidar, radar sensor and/or the camera (e.g., at the front in the direction of travel) does not detect any obstacle in the vicinity of the wheel at the time of the conspicuous acceleration values that exceed the load threshold, it can be assumed with a high degree of probability that the captured acceleration has a cause other than, for example, a curb impact.

The ultrasonic, lidar, radar sensor, and/or the camera can optionally capture the size and/or height and/or geometry of the obstacle. For example, appropriately designed (digital) image processing applied to the camera images provided by the camera can determine whether the obstacle has been hit or not. This information can also be used to determine whether the wheel hub motor is damaged or whether a warning alert should be output.

Accordingly, a further advantageous embodiment provides that a size and/or height and/or geometry of the obstacle is determined by the control device by way of the at least one ultrasonic sensor and/or the at least one camera and/or the at least one radar and/or lidar sensor. The size describes, e.g., a three-dimensional extent of the obstacle relative to an essentially flat roadway, the height merely describes a portion of the obstacle that protrudes above the roadway plane, and the geometry describes its shape.

In further advantageous embodiments, in order to enable even more precise detection of the damage, based on its size and/or height and/or geometry with regard to a damage potential for the wheel hub motor, the captured obstacle is classified into one of the following categories: dangerous, potentially dangerous and non-dangerous.

Furthermore, one embodiment of the disclosure is a motor vehicle having at least one wheel hub motor driving a wheel of the motor vehicle, at least one acceleration sensor for capturing acceleration values acting on the motor vehicle at least in a transverse direction of the motor vehicle during travel, and at least one control device which is adapted to carry out a method according to any one of the embodiments disclosed herein. The motor vehicle is preferably an electrically powered vehicle in which the wheel hub motor is designed as an electric wheel hub motor.

It should be understood that with respect to vehicle-related definitions of terms as well as the effects and advantages of vehicle-specific features, full reference may be made to the disclosure of analogous definitions, effects, and advantages of the method according to the disclosure, and vice versa. Repetition of explanations of analogous features, their effects, and advantages can thus be omitted in favor of a more concise description, without such omissions being construed as a limitation of any of the disclosed embodiments of the disclosure.

Further features and advantages of the disclosure will become apparent from the following description of non-limiting exemplary embodiments of the disclosure, which are explained in more detail below with reference to the drawings.

### BRIEF DESCRIPTION OF THE SEVERAL VIEWS OF THE DRAWINGS

In this drawing, the sole Figure schematically shows a part of a side view of a motor vehicle 10 according to an embodiment of the disclosure for explaining a method according to an embodiment of the disclosure.

### DETAILED DESCRIPTION

In the Figure, a wheel 11 of motor vehicle 10, which in the present case is an electrically powered motor vehicle, is driven by an electric wheel hub motor 12. It should be understood that motor vehicle 10 may have one or more additional wheels 11 (not shown), all or only a portion of which may be driven by correspondingly additional wheel hub motors 12. It is also possible for no additional wheel hub motor 12 to be provided, so that none of the one or more additional wheels 11 is driven.

Motor vehicle 10 has at least one acceleration sensor 13 (e.g., a vehicle dynamics control system and/or an airbag control unit (not shown)) for capturing acceleration values acting on motor vehicle 10 during travel, at least in a transverse direction of motor vehicle 10. In the illustration of the Figure, the transverse direction corresponds to a direction perpendicular to the plane of the drawing.

The acceleration values captured by acceleration sensor 13 are provided or fed to a control device 14 of the motor vehicle and evaluated by said control device 14. Control device 14 has, for example, a microcontroller, microprocessor, digital signal processor, or the like (not shown in the Figure).

As indicated in the Figure, motor vehicle 10 may have additional sensors, e.g., an ultrasonic sensor 15 and/or a camera 16 and/or a radar and/or lidar sensor 17, but not necessarily limited thereto. These sensors 15, 16, and 17 also provide their measured values to control device 14 for evaluation.

According to one embodiment of the method for detecting damage to wheel hub motor 11 driving wheel 12, acceleration values acting on motor vehicle 10 at least in the transverse direction of motor vehicle 10 are captured by way of acceleration sensor 13 during travel and evaluated by way of control device 14. Damage to wheel hub motor 11 is detected if the acceleration values captured in the transverse direction represent an acceleration of a lateral impact of wheel 11 against an obstacle (not shown) above a predeterminable load threshold. In this case, control device 14 can cause a warning message to be output to a user of motor vehicle 10, by way of which the detected damage to the wheel hub motor and, if applicable, measures to be taken by the user are communicated.

German patent application no. 102024117213.4, filed June 19, 2024, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

What is claimed is:

1. A method for detecting damage to a wheel hub motor of a motor vehicle that drives a wheel, the method comprising:
capturing, by a control device of the motor vehicle, acceleration values acting on the motor vehicle at least in a transverse direction of the motor vehicle by way of at least one acceleration sensor of the motor vehicle during travel;
evaluating, by the control device of the motor vehicle, the acceleration values acting on the motor vehicle at least in the transverse direction of the motor vehicle; and
detecting, by the control device of the motor vehicle, the damage to the wheel hub motor if the acceleration values acting on the motor vehicle in the transverse direction represent an acceleration of a lateral impact of the wheel against an obstacle above a predetermined load threshold.

2. The method according to claim 1, wherein the at least one acceleration sensor includes an acceleration sensor of a vehicle dynamics control system and/or an airbag control unit of the motor vehicle.

3. The method according to claim 1, further comprising:
causing, by the control device, a warning message to be output to a user of the motor vehicle, wherein the warning message indicates the damage to the wheel hub motor that is detected.

4. The method according to claim 1, further comprising:
determining whether the acceleration of the lateral impact of the wheel against the obstacle exceeds the predetermined load threshold based on an acceleration direction, an acceleration magnitude and/or an acceleration duration.

5. The method according to claim 1, wherein, in addition to the at least one acceleration sensor, at least one ultrasonic sensor of the motor vehicle and/or at least one camera of the motor vehicle and/or at least one radar and/or lidar sensor of the motor vehicle is used, by way of which the obstacle in a vicinity of the wheel is captured, and the damage to the wheel hub motor is detected if,
in addition to the acceleration values indicating the lateral impact of the wheel against the obstacle, the obstacle is also captured by way of the at least one ultrasonic sensor or the at least one camera or the at least one radar and/or lidar sensor.

6. The method according to claim 5, further comprising:
determining, by the control device, a size and/or a height and/or a geometry of the obstacle by way of the at least one ultrasonic sensor and/or the at least one camera and/or the at least one radar and/or lidar sensor.

7. The method according to claim 6, further comprising:
classifying the obstacle based on the size and/or the height and/or the geometry of the obstacle with regard to a damage potential for the wheel hub motor into a dangerous category, a potentially dangerous category, or a non-dangerous category.

8. A motor vehicle comprising:
at least one wheel hub motor that, in operation, drives a wheel of the motor vehicle;
at least one acceleration sensor that, in operation, captures acceleration values acting on the motor vehicle at least in a transverse direction of the motor vehicle during travel; and
at least one control device that, in operation:
evaluates the acceleration values acting on the motor vehicle at least in the transverse direction of the motor vehicle captured by the at least one acceleration sensor; and
detects damage to the wheel hub motor if the acceleration values acting on the motor vehicle in the transverse direction represent an acceleration of a lateral impact of the wheel against an obstacle above a predetermined load threshold.
